(19) United States
(12) Patent Application Publication
(10) Pub. No.: US 2009/0099855 A1
(43) Pub. Date: Apr. 16, 2009

(54) Method for Generating Software Variants

(76) Inventors: Nanjangud C. Narendra, Bangalore (IN); Karthikeyan Ponnalagu, Madurai (IN); Biplav Srivastava, Noida (IN); Guruduth S. Banavar, Petham Manor, NY (US)

Correspondence Address: FREDERICK W. GIBB, III;Gibb Intellectual Property Law Firm, LLC, 2568-A RIVA ROAD, SUITE 304, ANNAPOLIS, MD, 21401, US

(21) Appl. No.: 11/870,636

(22) Filed: Oct. 11, 2007

(51) Int. Cl. G06Q 99/00; G06F 17/00

(52) U.S. Cl. 705/1

(57) ABSTRACT

A method generates, based on an original business process comprising at least one component, a variant business process comprising at least one variation compared to the original business process. The method comprises the steps of developing a variant meta-model, representing the at least one variation, instantiating and verifying the developed variant meta-model portion to obtain a variant model, and implementing the variant model to generate the variant. The method also comprises developing a formalism for defining the at least one variation.

### TECHNICAL FIELD

The present invention relates to a method for generating software variants, and in particular, to a method for generating software variants by variation oriented engineering.

### BACKGROUND OF THE INVENTION

Software service organizations developing custom business software solutions that implement business processes of the clients are facing an increased pressure to enhance profitability. One way of doing this is via software components reuse. The emergence of service oriented architecture (SOA), with its emphasis on loose coupling and dynamic binding between components, promises to enable more effective software reuse by packaging business processes and their components as reusable services accessible only via their interfaces. One obstacle against the realization of this vision is the cost involved in designing and generating software variants to meet varied customer requirements. This problem results in the current labour-intense situation in the software services industry today.

Accordingly, it is desirable to develop a method for more efficient generation of software variants.

### SUMMARY OF THE INVENTION

According to one aspect of the invention, there is provided a method for generating, based on an original business process model and implementation comprising at least one component, a variant business process model and implementation comprising at least one variation compared to the original business process model and implementation, and which generates the same outputs for the same inputs as of the original business process model and implementation, by

a) developing a meta-model of the business process model, comprising a static meta-model portion and a variant meta-model portion, representing the at least one variation;

b) instantiating and verifying the developed variant meta-model portion to obtain a variant model; and

c) implementing the variant model to generate the variant business process implementation.

According to a second aspect of the invention, there is provided an electronic system that is programmable for generating, based on an original business process model and implementation comprising at least one component, a variant business process model and implementation comprising at least one variation compared to the original business process model and implementation, the electronic system comprising computational means programmable for:

a) developing a meta-model comprising a static meta-model portion and a variant meta-model portion, representing the at least one variation;

b)instantiating and verifying the developed variant meta-model portion to obtain a variant model;

c) implementing the variant model to generate the variant; and

d) using a developed formalism to define the at least one variation.

According to a third aspect of the invention, there is provided a computer program product having a computer readable medium having an executable computer program recorded therein for automatically generating, based on an original business process comprising at least one component, a variant business process comprising at least one variation compared to the original business process, said computer program comprising means for:

a) developing a meta-model of the business process, the meta model comprising a static meta-model portion and a variant meta-model portion, representing the at least one variation;

b) instantiating and verifying the developed variant meta-model portion to obtain a variant model;

c) implementing the variant model to generate the variant; and

d) using the developed formalism to define the at least one variation.

### BRIEF DESCRIPTION OF THE DRAWINGS

In the drawings:

FIG. 1 is a schematic flow diagram of a method for generating software variants embodying the invention.

FIG. 2 is a schematic structural diagram of the meta-model of FIG. 1.

FIG. 3 is a schematic diagram of an original business process.

FIG. 4 is a schematic diagram of an alternative business process that is a variant of the business process illustrated in FIG. 2.

FIG. 5 is a schematic diagram of a variation feature associated with the original business process of FIG. 3.

FIG. 6 is a schematic diagram of a variant version of a section from the alternative business process of FIG. 4.

FIGS. 7 and 8 are conceptual models of a service variation and a business variation, respectively.

FIGS. 9 to 11 are schematic diagrams of variation constraints for different types of variations.

FIG. 12 is schematic diagram representing one type of variation expressed through other types of variations.

FIG. 13 is a schematic diagram of variation constraints applied to an application example.

FIG. 14 is a schematic diagram of the implementation steps and the conceptual hardware modules associated with the variant model embodying the invention.

FIG. 15 is a schematic service invocation diagram of the original business process of FIG. 3.

FIG. 16 is a schematic diagram of the variation model for the original business process of FIG. 3.

FIG. 17 is a schematic service invocation diagram of the variant business process of FIG. 4.

FIG. 18 is a screen printout of a list of identified variation features needed for derivation of the variant model.

FIG. 19 is a screen printout of instantiation of A2-type variation features.

FIG. 20 is a screen printout of an application of an instantiated A2-type variation feature on the Determine Liability service.

FIG. 21 is a screen printout of an association between B1-type variant with its constituent A-type variation features.

### DETAILED DESCRIPTION

The method in accordance with the present invention is based on the so called Variation Oriented Engineering (VOE) approach. VOE employs Variation-oriented Analysis (VOA) and Design (VOAD) paradigm and utilizes service oriented architecture (SOA) and its underlying process-based approaches to formally model key types of variations, including business process variations. The meta-model that is constructed can be used to rapidly re-configure or customize a business process so as to make it applicable to different customer requirements. This facilitates code reuse and minimises labour costs. The approach employs constraint-based formulation of the variations, and shows how this formulation can be used to verify the semantic correctness of the business process in the presence of variations. Hence this represents an end-to-end approach spanning business processes to their SOA implementation to formally model and develop these variants, so that the reuse of solutions with variants can be facilitated.

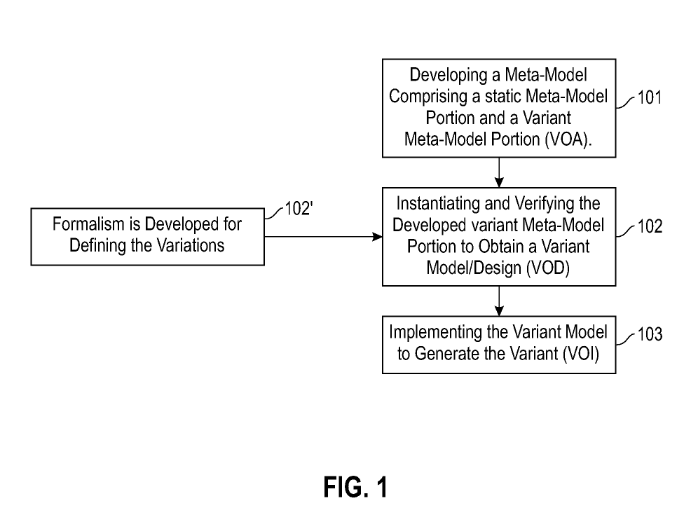

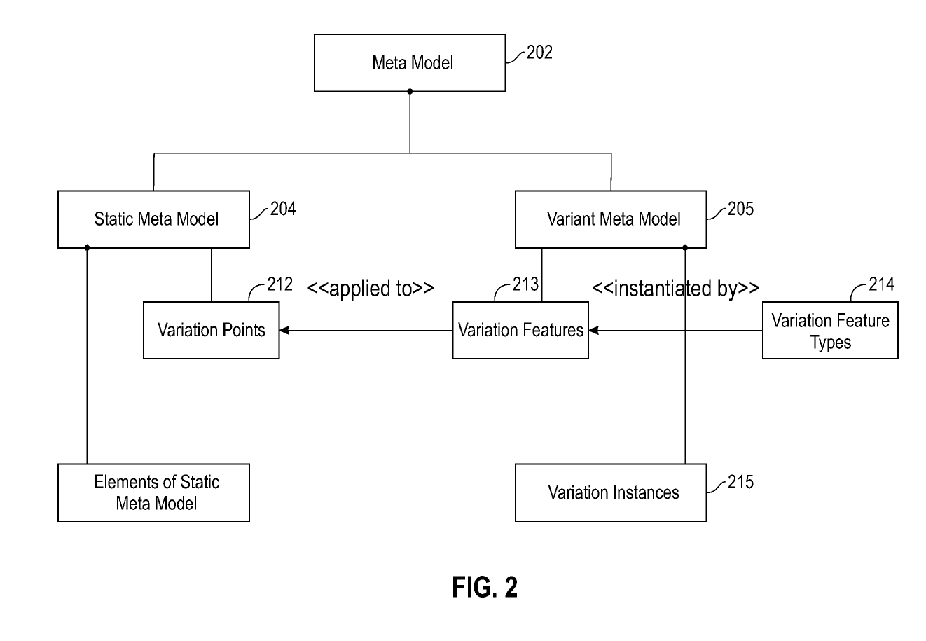

The method consists of three steps—Variation-Oriented Analysis (VOA), Variation-Oriented Design (VOD) and Variation-oriented Implementation (VOI). The first step 101, VOA, is shown in FIG. 1 and defines a static part and a variable part of a possible software solution, as shown in FIG. 2. A meta-model is developed, for representing variations, and a formalism, for defining the variations. In step 102, variation-oriented design (VOD), a variant model is instantiated for a particular solution from the variation meta-model at the VOA step. In addition, the variant model is enhanced in two ways that are specific to business process-based business process. First, the variations are modelled at the service (i.e., component implementation) level and at the business process level, with business process level variations expressed as suitable combinations of service level variations. Second, the variations are formally represented via a constraint-based formulation (102′), which can be used to verify the semantic correctness of the variant business process. This would ensure that the introduced variations do not cause design errors in the generated variant. The third step 103, VOI, is responsible for producing an implementation of the variant model developed and verified at the VOD step. This implementation can be done either manually or via automated code generation, or a combination thereof. However, since many business solutions involve integration with external and legacy components, the discussed method uses aspect-oriented programming for this integration.

A specific description will be offered in support of the above presented conceptualisation embodying the invention, by way of an example.

### EXAMPLE

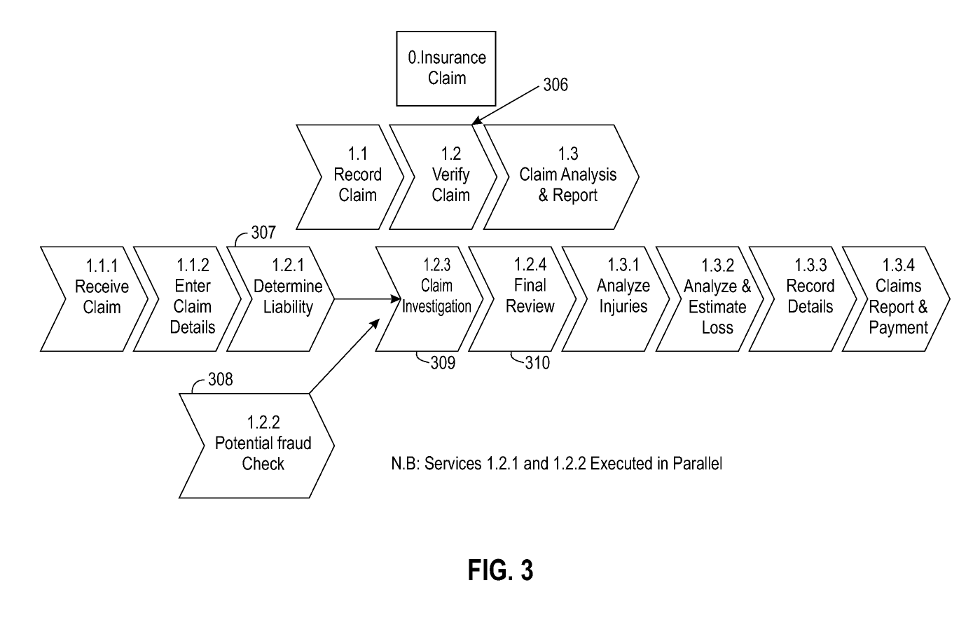

A basic insurance claim process solution (Solution 1) is shown in FIG. 3. The illustrated process consists of three major sub-processes—recording a claim, verifying the claim, claim analysis and report. The net output of this process is an evaluation of an insurance claim. If the claim is accepted, the output also includes information in relation to the payment to be made to the applicant. The section of the business process that is relevant to the invention is the Verify Claim sub-process 306. In this sub-process, the Determine Liability service 307 and the Potential Fraud Check service 308 are firstly executed in parallel, and their results sent to Claim Investigation service 309. A final review of the verified claim is then implemented by Final Review service 310.

An assumption will now be made that the above Solution 1 needs to be altered to another process (Solution 2) that is tailored to a new group of “high priority” customers. For the purpose of this alteration, the following changes are necessary:

Improving cycle time for the Verify Claim sub-process 306; and

Improve fraud checking—a new and improved fraud checking module needs to be incorporated for high value claims.

Based on these changes, the following variations to Solution 1 are anticipated:

Determine Liability & Potential Fraud Check services 307 and 308 to be outsourced for improved speed;

Potential Fraud Check service 308 should be modified to take into account the extent of liability. This modification would eventually involve changes in the business logic of the solution; and

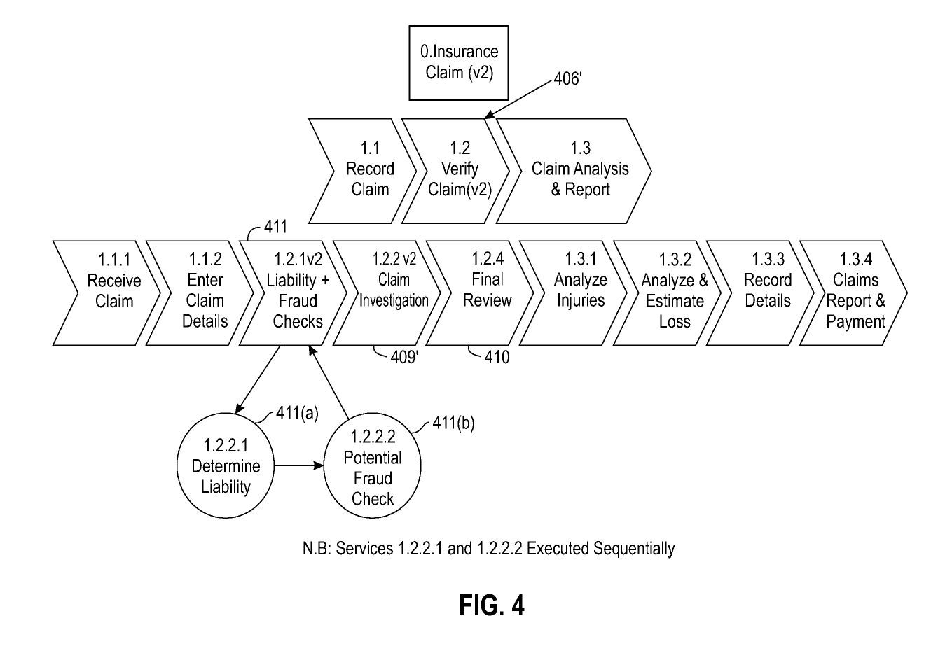

A new Liability & Fraud Checks service 411 (see FIG. 4) to be added, where liabilities are determined in 411(a) and a potential fraud check is performed in 411(b).

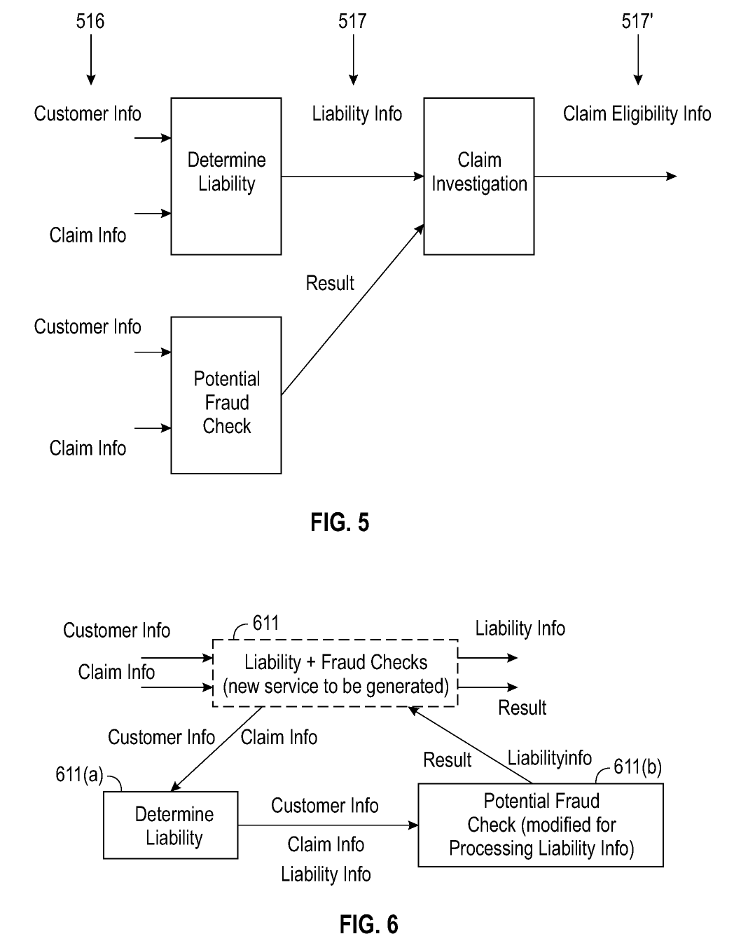

As shown in FIG. 4, these variations result in Solution 2, viz., a modified Verify Claim sub-process 406. The Claim Investigation service 409 and Review Claim Service 410 are unchanged. The original inputs 516 and outputs 517 and 517′ for the service to be modified in Solution 1 are clearly identified in FIG. 5, while the new service components 611, 611(a) and 611(b), as well as the necessary input/output modifications to transfer Solution 1 into Solution 2, are shown in FIG. 6.

The suggested approach allows modelling the changes as variations on existing services, with such variation modelling being formally captured via a meta-model, modification methodology and tools. Such an approach makes it easy to design services as reusable assets with all possible variations modelled upfront. From these variations then suitable variants of the service can be quickly instantiated in response to different customer requirements.

The steps 101 to 103 from FIG. 1 will now be described in detail with reference to the insurance-claim example discussed above.

### Variation-Oriented Analysis (VOA)

The VOA step 101 consists of developing a meta-model including a static part 204 (static meta-model) and a variable part 205 (variable meta-model), shown in FIG. 2, so as to separately model the variable components of any service or business process. The static meta-model 204 is not expected to change over time. The variant meta-model 205 represents an enhancement of the originally developed core meta-model and has several components. This is facilitated by the division of business processes into groups with similar functionality.

One component includes the Variation Points 212, which are the points in the business process where variations can be introduced. There are, in turn, two types of variation points. Implementation variation points are the points in the component implementation where the implementation of certain methods can be modified, without affecting the externally observable behaviour of the program. Specification variation points are the points at the interface of the component implementation, which can be modified. This may necessitate changes to the internal implementation of the component itself, which are specified via the implementation variation points. Specification variations could therefore involve adding new input/output data, and/or removing input/output data to the component. This is facilitated by the arrangement of component implementations into groups with similar functionality.

Another component of the variant meta-model 205 includes the Variation Features 213, which further refine the variation points 212, by specifying the nature of the variation and its specific applicability. These features can be grouped into Variation Feature Types 214 for easier classification. For example, variation types such as type, process and rules, are represented here as Variation Feature Types. One variation point can admit more than one variation feature, and one variation feature can be applied to more than one variation points.

A further component of the variant meta-model 205 are Variation Instances 214, which are the actual variations resulting from the application of the Variation Features 213 at the Variation Points 212. These will be explained in detail later in the text.

It has to be noted that the discussed meta-model is a highly generic representation, and is applicable to any types of variations in business process and their components. The meta-model is SOA-based and is directed to modelling service-level and business process-level variations. Since the meta-model is highly conceptual, it can be treated as a template from which actual variation-oriented design can be derived. This is accomplished in two major tasks in the second VOD step 102.

At the service level, both implementation and specification variation points are considered. However, since the example embodiment is limited to the restricted case where the Solution 1 needs to be transformed into Solution 2 without a change in externally observable behaviour (i.e. semantics), at the process level the scope the presented description is limited to implementation variation points.

In the example, a variation point is presented by the method in Determine Liability service 307 for calculating insurance liability. A “variation feature” in this case is associated with the requirement to replace that method by a different method. This Variation Feature could be of a rule type, signifying that a business rule change would result in the action specified by the variation feature. The modified Determine Liability service 411 in this case represents a “variation instance”.

The discussed approach resembles inheritance-based variations from the object-oriented (OO) domain only in the implementation variation points. The well-known “open to extension-closed to modification” principle prevalent in the OO domain does not apply for specification variation points.

### Variation Oriented Design (VOD)/Business Process Variations

Based on the meta-model described above, the variation instances in a business process-based solution can be broadly categorized into two cases that will be referred to as A and B.

Case A variations are internal variations that do not require variation in the process flow, i.e. service level variations. Case A variations are classified as follows:

Sub-case A1—changes only to the internal implementations of the services, without requiring changes to their interfaces. Such changes are realized via implementation variation points.

Sub-case A2—changes to the interfaces of the services, which also require implementation changes. Such changes are realized via specification variation points. These changes also involve concomitant implementation changes of A1-type:

Input data is received by the service. This could be triggered by:
Change in the output data sent by a previously executed service, which is to be processed by the service in question.
Change in the input data needed by a service which is to be executed later. This data may have to be transmitted by the service in question, perhaps after modification.

Output data is sent by the service;
This is a trigger for modifications to the services to be executed next, i.e. those that are dependent on the service in question.

Case B variations, also known as external variations, are variations in the application flow of the business process. These are realized via combinations of the A1 and A2 type variations, and are classified as follows:

B1: Add service sequentially—a service Sj is added between Si and Sk;
If this variation does not cause any modifications to the inputs of Sk and outputs of Si, then the output methods of Si and input methods of Sk have to be redirected towards Sj. This is realized as an A1-type change, since this will involve modifying the input and output methods for the services Si and Sk.
If modifications are required, a variation is realized as A2-type change on Si and/or Sk, and needs to be modeled as such.

B2: Delete service—service Si+1 (predecessor is Si and successor is Si+2) is deleted;
If this does not cause any modifications to the outputs of Si or the inputs of Si+2, then the output methods of Si and input methods of Si+2 need to be redirected towards each other, resulting in an A1-type change.
However, if modifications are required, this will require an A2-type change on Si and Si+2, and needs to be modeled as such.

B3: Add service in parallel—a service Sj is added between Si and Sk in parallel. This would require A2-type changes to Si and Sk;
If no modifications to the inputs of Sk and outputs of Si are effected, then additional methods would need to be added to each service to accommodate the new service Si, thus defining an A1-type change.
However, if modifications are required, then this will be realized as A2-type change on Si and Sk, and needs to be modelled as such.

B4: Add dependency between two services. This is an A2-type change, requiring interface changes to the services. Depending on the nature of the dependency, this also could require A1-type changes to either service.

B5: Delete dependency between two services. This is akin to deleting an edge in the business process. The variation is similar to B4, in that it would require an A2-type change, with an additional A1-type change if needed.

For the insurance-claim example of FIGS. 3 and 4, the following Table 1 shows possible A- and B-type variations and the related mapping to the constructs in the associated meta-model.

TABLE 1
Sample A- and B-type Variations

| | Variation | Variation | |
|---|---|---|---|
| | Points | Feature Types | Variation Features |
| Determine | calcLiability method | A2- | Add the following outputs: |
| Liability | | type | custInfo, claimInfo |
| Service | | | |
| Potential | fraudCheckAlgo | A1- | Modifed operation: |
| Fraud | method | type | NewfraudCheckAlgo |
| Check | Return | A2- | Add the following output: |
| service | statement | type | LiabilityInfo |
| Insurance | Enter Claim | B1- | Add (modified) Potential |
| Claims - | Details service, | type | Fraud Check service between |
| overall | Claim Investigation | | Determine Liability service & |
| solution | service, Determine | | Liability + Fraud Checks service |
| | Liability service, | | Add (new) Liability + Fraud |
| | Potential Fraud | | Checks service between Enter Claim |
| | Check service | | Details service (not shown) & |
| | | | Determine Liability service |

### Formal Variation Modeling of Services and Business Processes

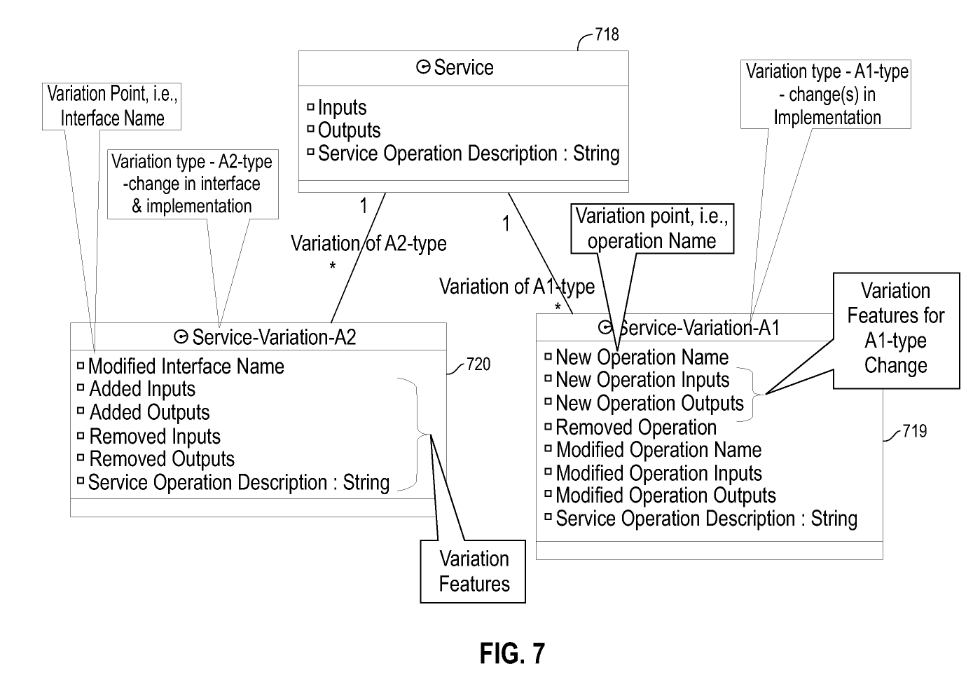

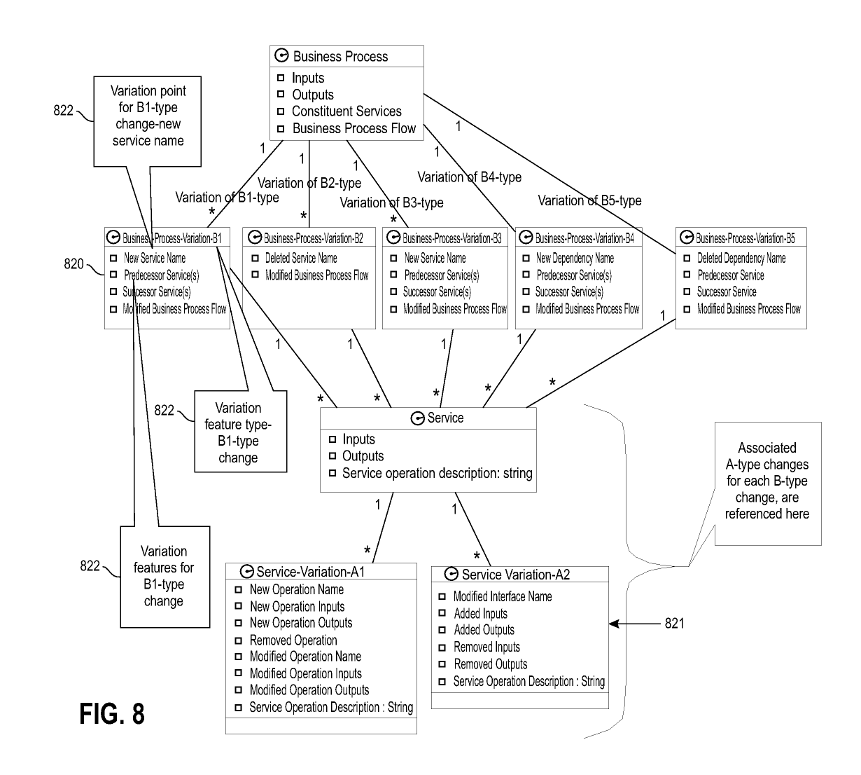

The conceptual model for variation modelling of A1-type changes 719 and A2-type changes 720 in a service 718, as well as the associated meta-model constructs, are schematically depicted in FIG. 7. Similarly, the conceptual model for the B-type variations 821 at the process level is schematically depicted in FIG. 8. These conceptual models serve as design templates from which the actual variants are generated. For the sake of clarity and succinctness, FIG. 8 depicts details 822 only for the B1-type variations 820. The A-type changes 821 associated with each B-type change 820 are also shown in FIG. 8. Details of the prototype implementation associated with FIGS. 7 and 8 will be described in the following paragraphs.

The developed models are independent of modelling languages such as UML, and also can be used in DSL-based approaches such as Microsoft's Software Factories.

### Constraint-Based Specification of Variations

The described approach essentially determines, for each process variant in a group, an implementation including mapping to the appropriate variant from the component implementations. However, such an approach makes sense only if it can be verified whether the semantics of the varied business process are preserved when Solution 1 is transformed into Solution 2. Accordingly, the proposed variations are modelled in the form of a constraint satisfaction problem (CSP). The consistency among the constraints, indicating whether the introduced variations are able to preserve the semantics of the solution, is checked via a constraint checker (E. Tsang. Foundations of Constraint Satisfaction. Academic Press, ISBN 0-12-701610-4, 2003).

The disclosed formulation only verifies the functional semantics of the business process in terms of its inputs and outputs. Verification of adherence to non-functional semantics, such as business rules external to the process, is beyond the scope of this formulation. However, even this limited constraint checking improves significantly the overall verification process, especially when a large number of variations are to be implemented, and was found necessary for creating Solution 2 as a variant of Solution 1.

The constraint-based specification for each variation feature type, whether A-type of B-type, comprises the following parts:
Variation variables—these represent the basic change constructs, such as adding/removing inputs to a service/process, etc.
Variable domains—these represent the values that apply to each variation variable.
Constraints—these represent the constraints against any subset of the variation variables, and can be generally expressed as Boolean formulas. In this paper we express them via either equality or inequality constraints.

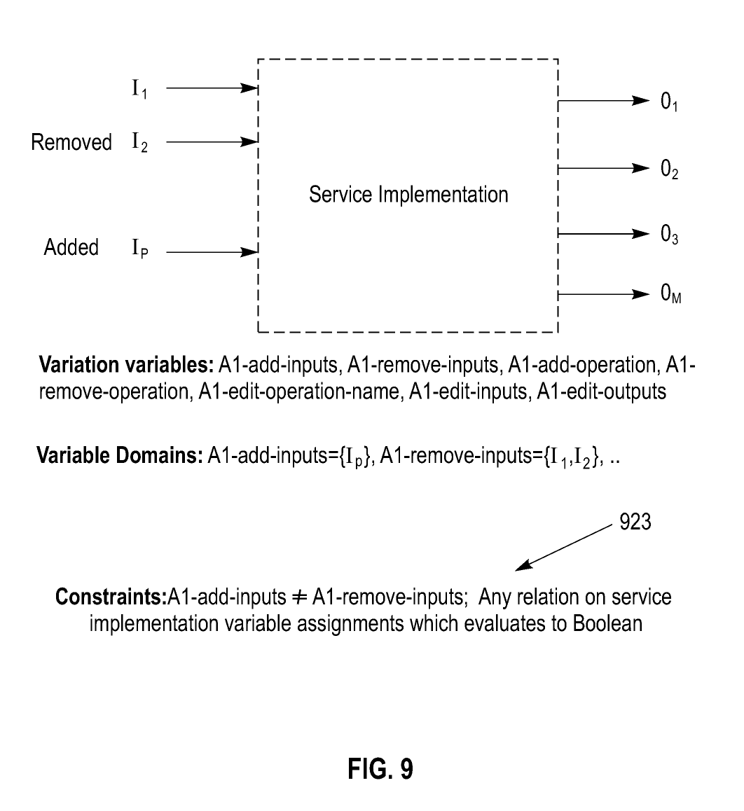

Sample A1-type variation constraints 923 are indicated in FIG. 9. Variation variables include adding inputs (Iₚ) and removing inputs (I₁, I₂), editing inputs and adding/removing outputs Oᵢ. A key constraint here is to ensure that the set of added inputs Iₚ is different from the set of removed inputs I₁ and I₂, which is expressed as an inequality constraint.

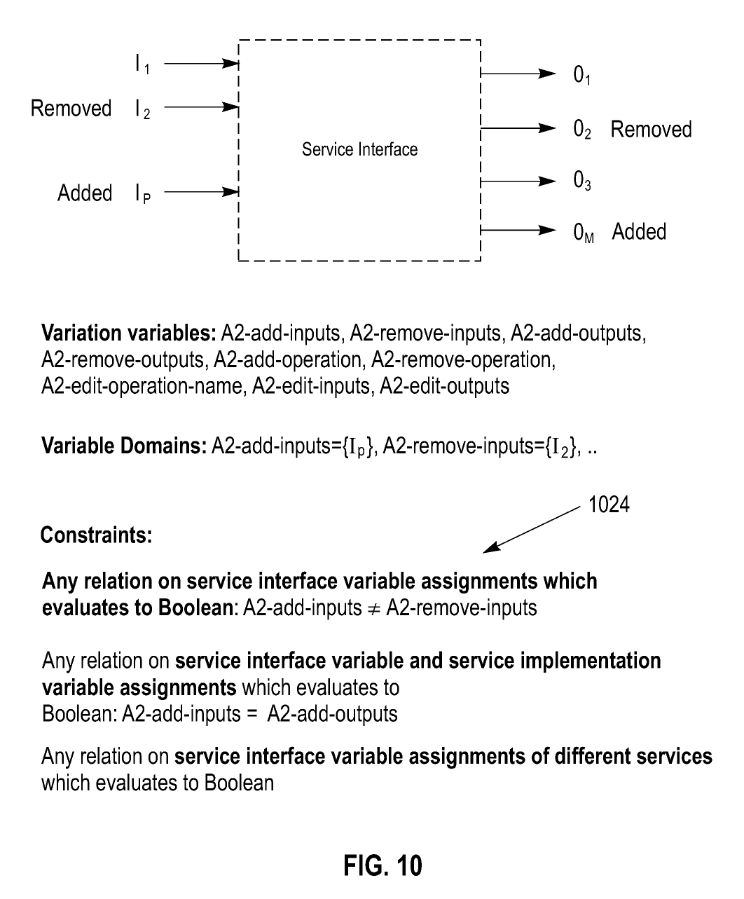

Similarly, an A2-type variations is expressed as in FIG. 10, with some representative constraints 1024. Representing A2-type variations is more complicated, since the interface that the service exposes, also changes. Some key variation constraints here include: the added inputs Iₚ are disjoint from removed inputs I₁ and I₂ (inequality constraints) and the added inputs Iₚ are to be reflected in added outputs O_{M} (the equality constraint depicted in FIG. 9).

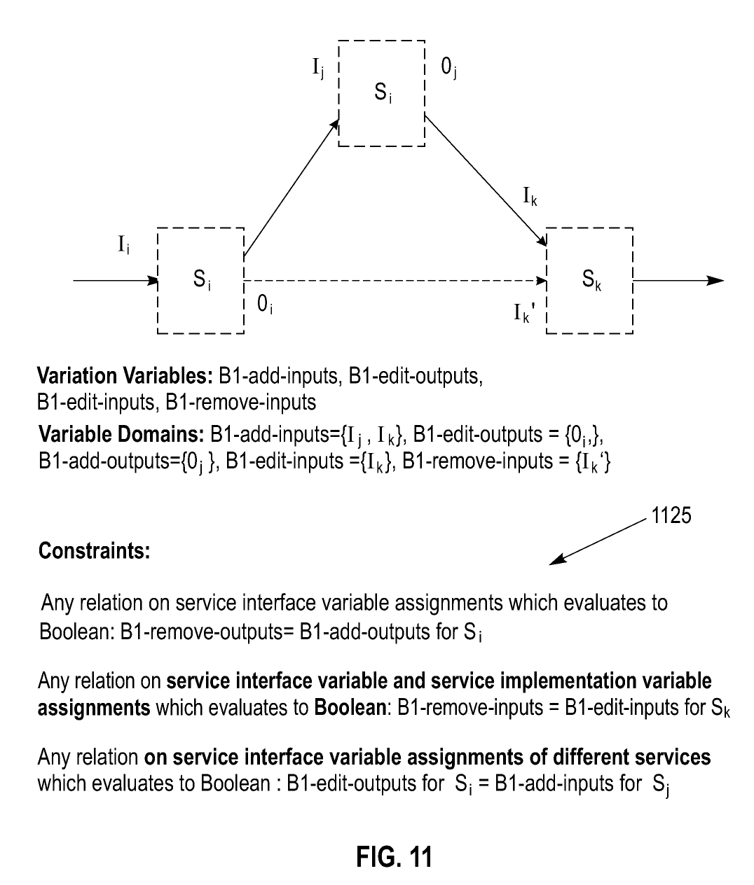

B1-type variations and some representative constraints 1125 are represented in FIG. 11. This type of variations, which is effected at the process level, also consists of variables such as added/removed inputs, added/removed outputs, etc. as depicted in FIG. 11. Some key constraints here include: the removed outputs for Si being the same as the added outputs for Sj (equality constraint) and the removed inputs for Sk being the same as the edited inputs for Sk (equality constraint). In other words, for Si, all its outputs have to be accounted for, i.e. either directed to Sk or to Sj. The main purpose of these constraints is to specify the changes that would occur when Sj is inserted sequentially between Si and Sk.

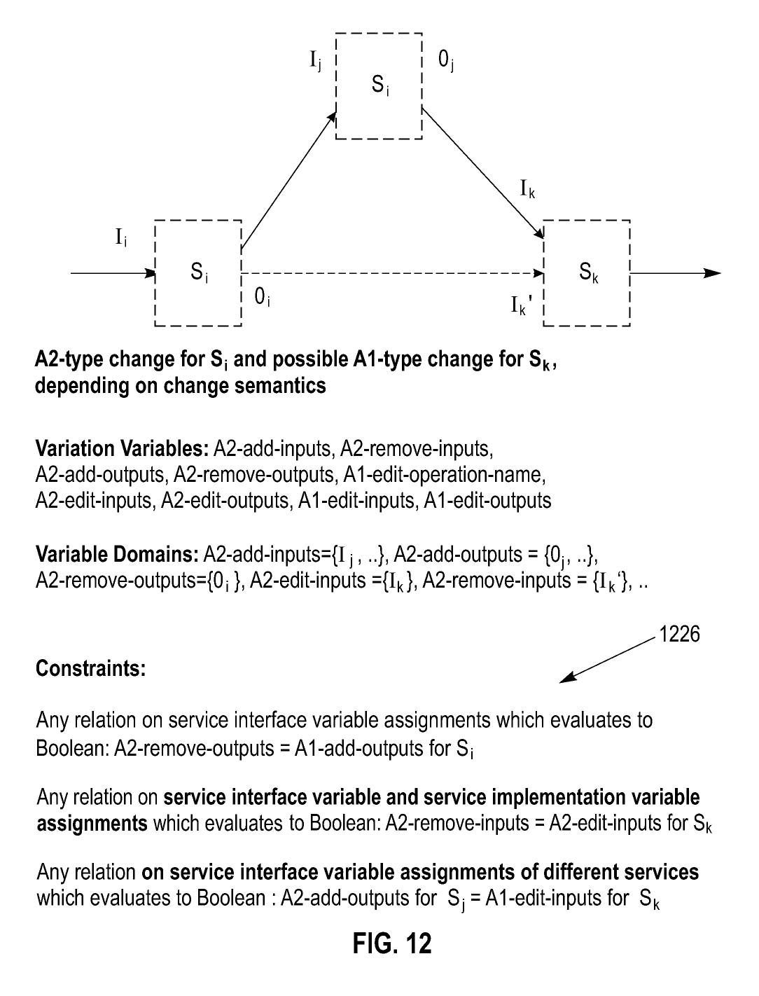

In order to actually check the consistency of the B1-type constraints, they need to be translated into their respective A1/A2-type variation constraints. This is represented in FIG. 12. At the individual service level, the B-type equality constraint, defining that all outputs for Si have to be accounted for, can be translated to its equivalent A2-type equality constraint, i.e. the uppermost constraint 1226 shown in FIG. 12. Additionally, consistency between the added outputs for Sj and edited inputs for Sk, is specified via the lowermost constraint 1226 depicted in FIG. 12.

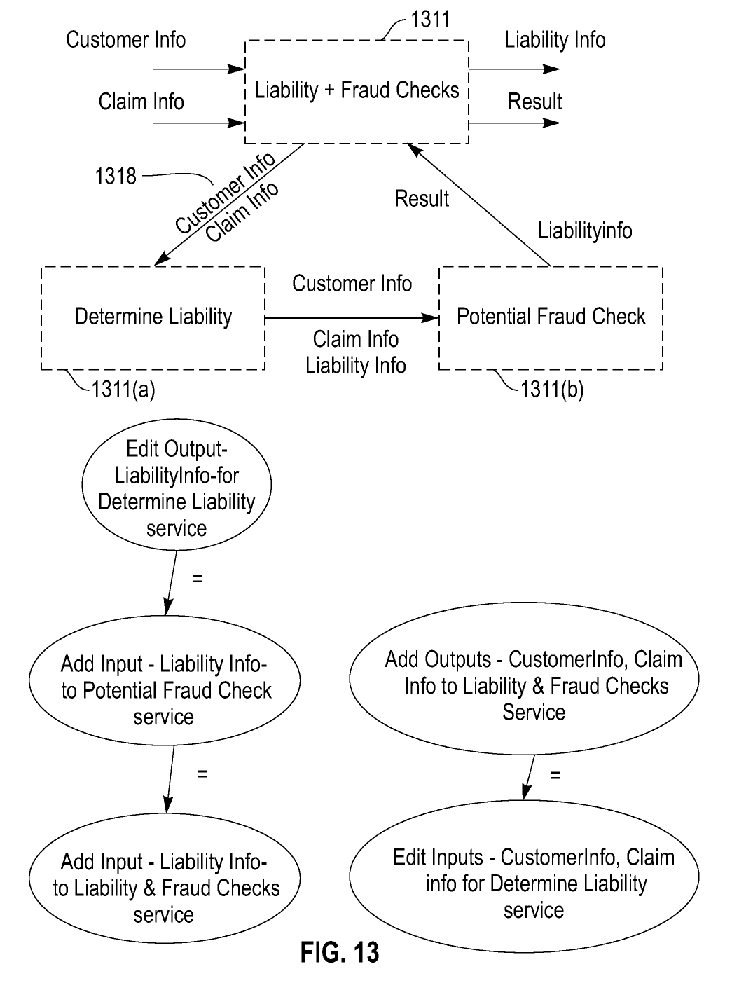

FIG. 13 presents a sample constraint graph displaying some constraints from the insurance claim example. These constraints specify that the new output of the Determine Liability service 1311(a) (see also 411(a)) should be an input to Potential Fraud Check service 1311(b) (see also 411(b)). In addition, this also should be an input to the monitoring Liability and Fraud Checks service 1311 (see also 411). Similarly, the added outputs 1318 to Liability and Fraud Checks service 1311 (i.e. customer and claim information) also should be inputs to the Determine Liability service 1311(a).

Similar constraints can be specified for all other B-type variations, both as B-type variation constraints, and as their equivalent A-type variation constraints. For the sake of clarity, they are listed in Table 2, located at the end of the description. All these constraints can then be fed into a constraint checker and verified for consistency.

### Variation Oriented Implementation (VOI)—Realizing VOA & VOD

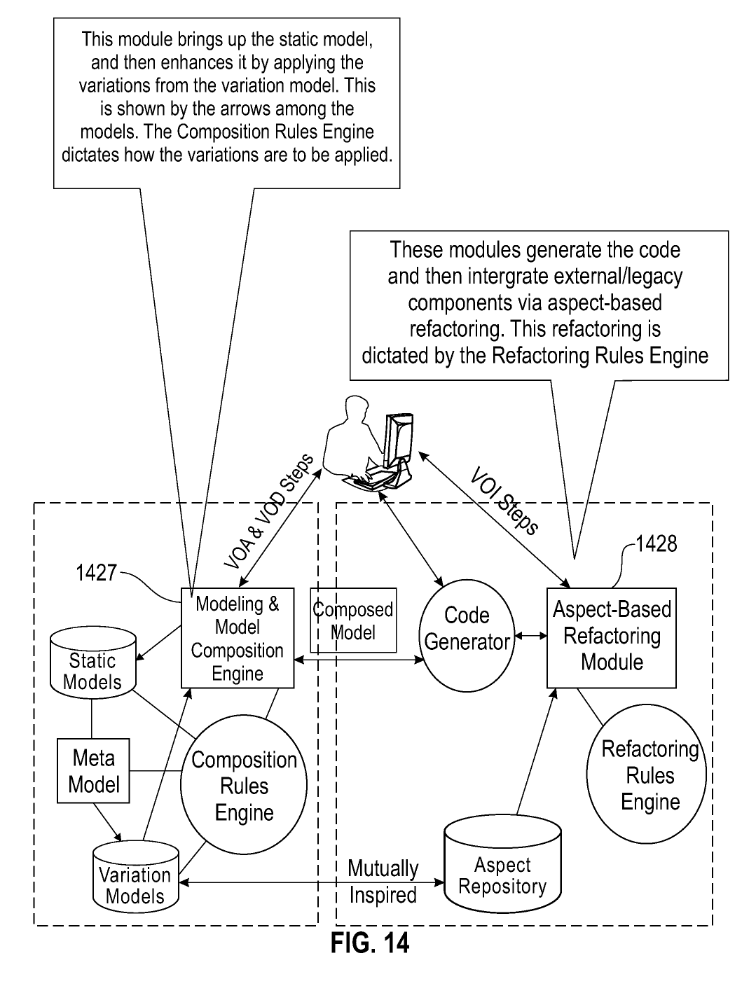

The discussed VOI approach and system architecture is pictorially explained in FIG. 14. The approach assumes that the customer requirements have been translated into variations necessary to produce a semantically consistent Solution 2. VOI therefore consists of the following steps:

Model composition, performed by the model composition engine 1427 shown in FIG. 14. In this step, the variation models for each variation are composed into the business process model for Solution 1. When an automated code generation facility is available, code is directly generated from the composed model, giving rise to Solution 2. We demonstrate model composition via IBM's Rational Software Architect (RSA).

Aspect-based Refactoring, performed by the Aspect-based Refactoring Module 1428 shown also in FIG. 14. This module is used where an automated code generation facility is not available or where developing Solution 2 involves integrating legacy and external components for which only source code and/or programming interfaces (via APIs) are available. In such a case, aspect-based refactoring is resorted to.

### Model Composition

This step assumes the existence of the primary design model for the Solution 1, augmented with variation-oriented information. The variant Solution 2 is to be generated by choosing the appropriate variations to be incorporated into Solution 1. Therefore, the following steps are accomplished (hereinafter in this description, a reference to Solution 1 or Solution 2 will refer to their respective Verify Claim sub-process only.)

First, the changes identified in the previous steps are mapped against the variation models provided by the design of Solution 1. For example, for the B1-type change, it needs to be verified whether the design of Solution 1 provides for such a change to be represented as a variation model so that this model can be automatically composed into Solution 1.

Second, each change is taken up for implementation. If such a change implementation can be automated, then the variation model is composed into the primary design model, as will be shown later in the text. The advantage of such a composition approach is that a unified model of the solution is developed for which code can be generated automatically from the process model.

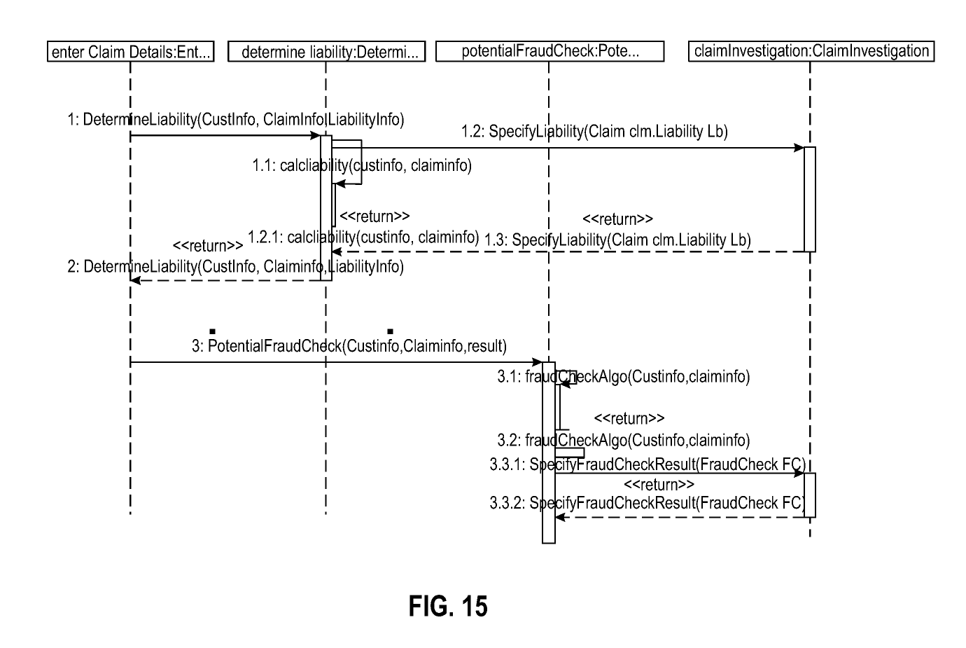

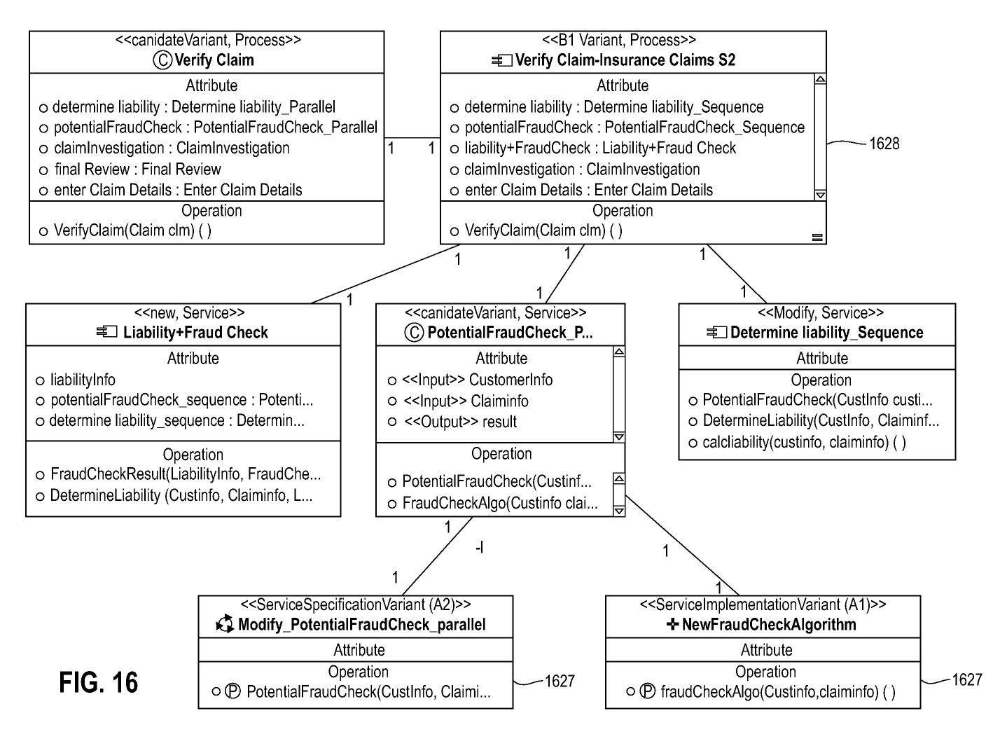

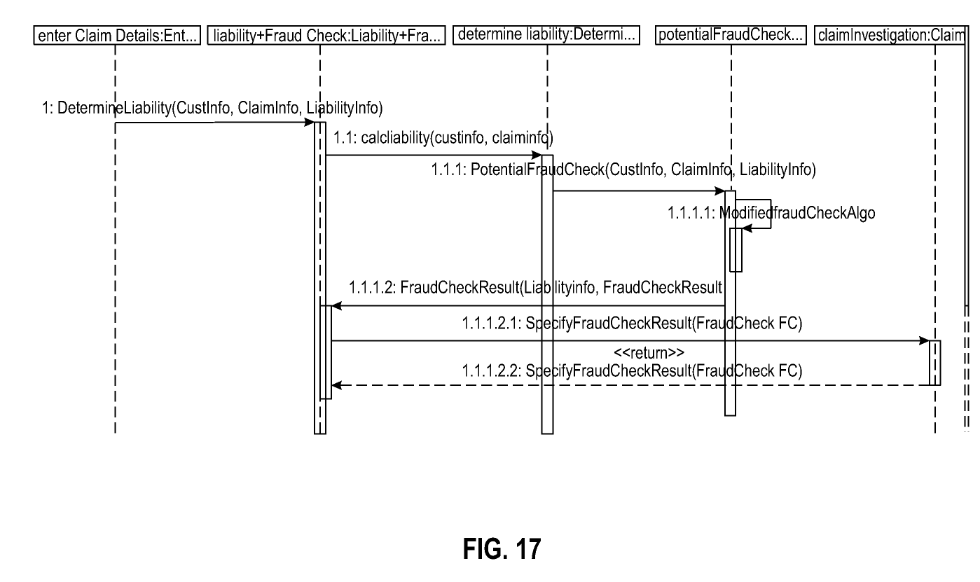

FIG. 15 illustrates the original service interaction diagram for Solution 1. Due to the limitations of RSA, the business processes can be only depicted via service interaction diagrams, and not as business process flows. The required A- type variations 1627 and B-type variations 1628 needed to transform Solution 1 into Solution 2, are depicted in FIG. 16. The transformation of the design of Solution 1 into that of Solution 2 results in the service interaction diagram for Solution 2 shown in FIG. 17.

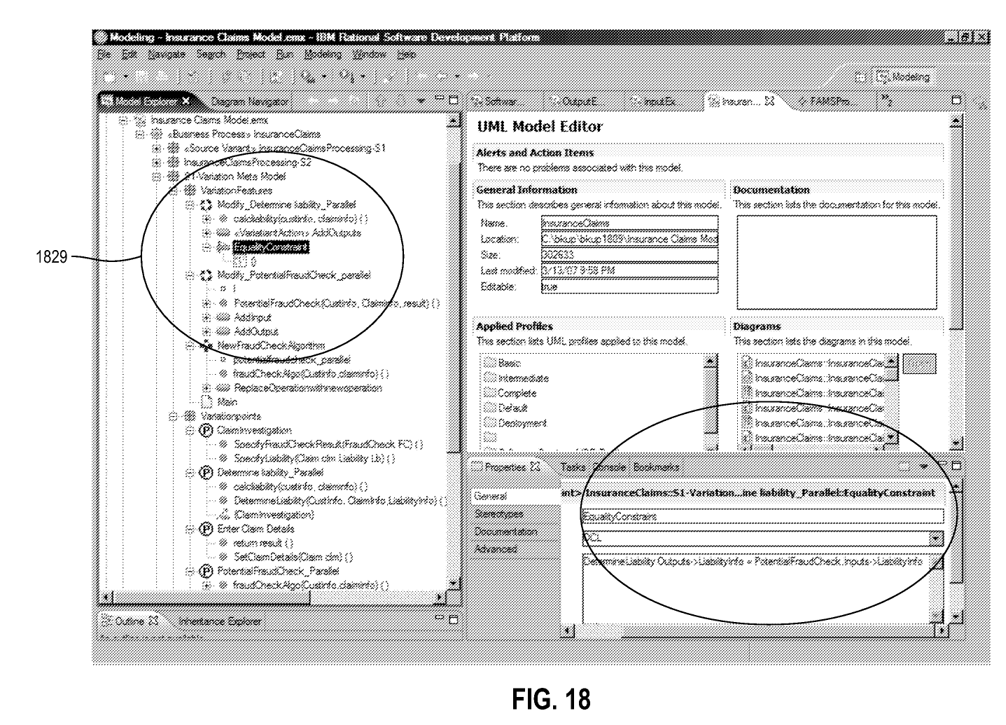

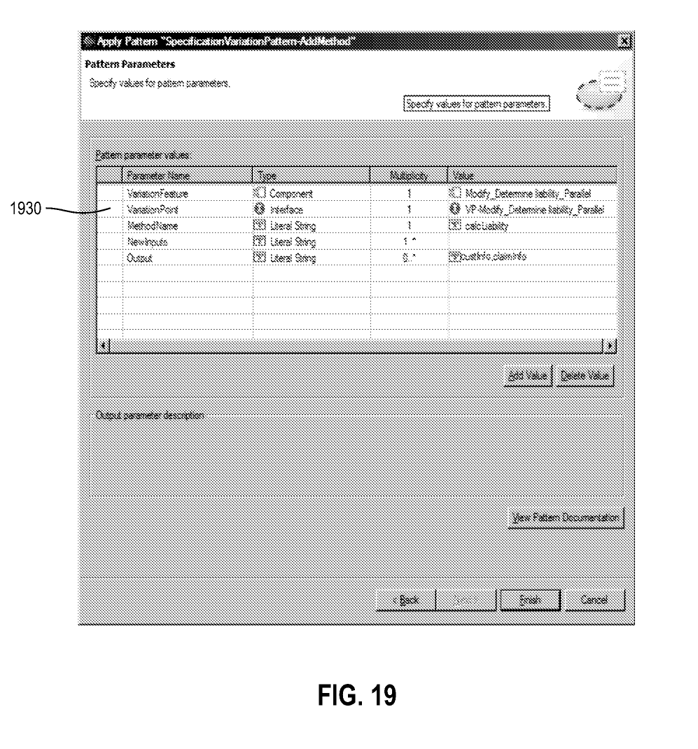

The identified Variation Features 1829 needed to generate this variation model and the subsequent derivation of Solution 2, are listed in FIG. 18, along with the Variation Points where they are applied. In a modelling tool such as RSA, applying a variation feature on a variation point is simply a matter of applying a pattern on an existing design. FIG. 19 shows how an A2-type variation feature type is instantiated via the specification of the appropriate parameters 1930.

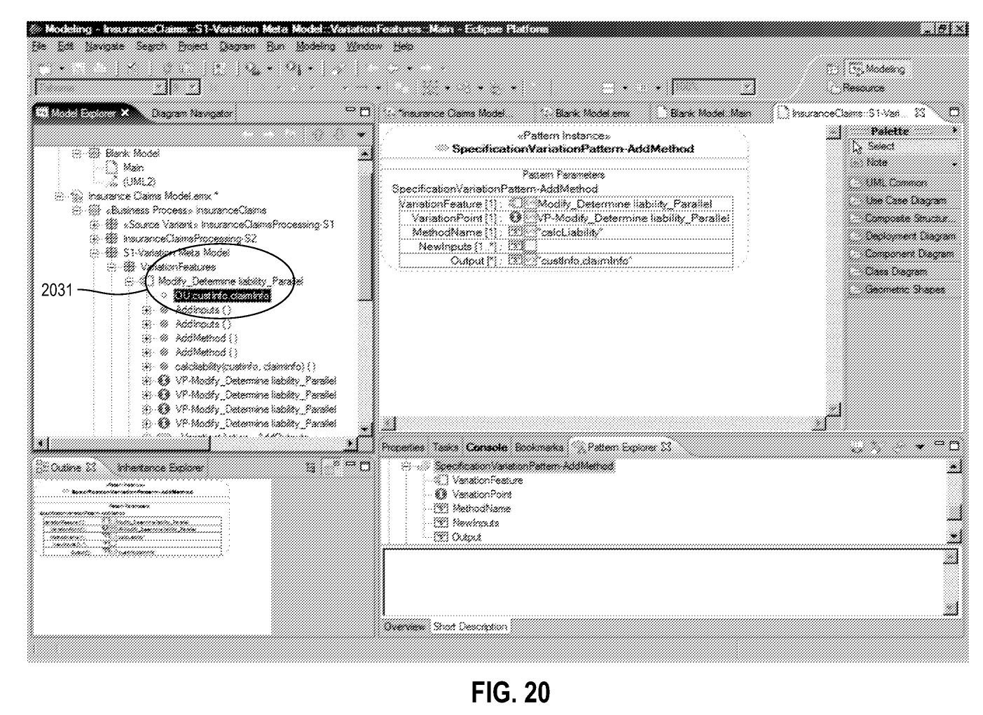

FIG. 20 shows the application of the instantiated A2-type variation feature on the Determine Liability service 411(a)(as per the top row of Table 1). Similarly, a B-type variation feature is instantiated as a combination of A-type variation features. In the discussed method, the mapping between a B-type variation feature and its associated A-type variation features can be specified manually. In other words, B-type variations are modelled as collections of A-type variations. However, it should be apparent to a person skilled in the art that this selection of A-type variation points and variation features from an instantiated B-type variation feature, also can be automated.

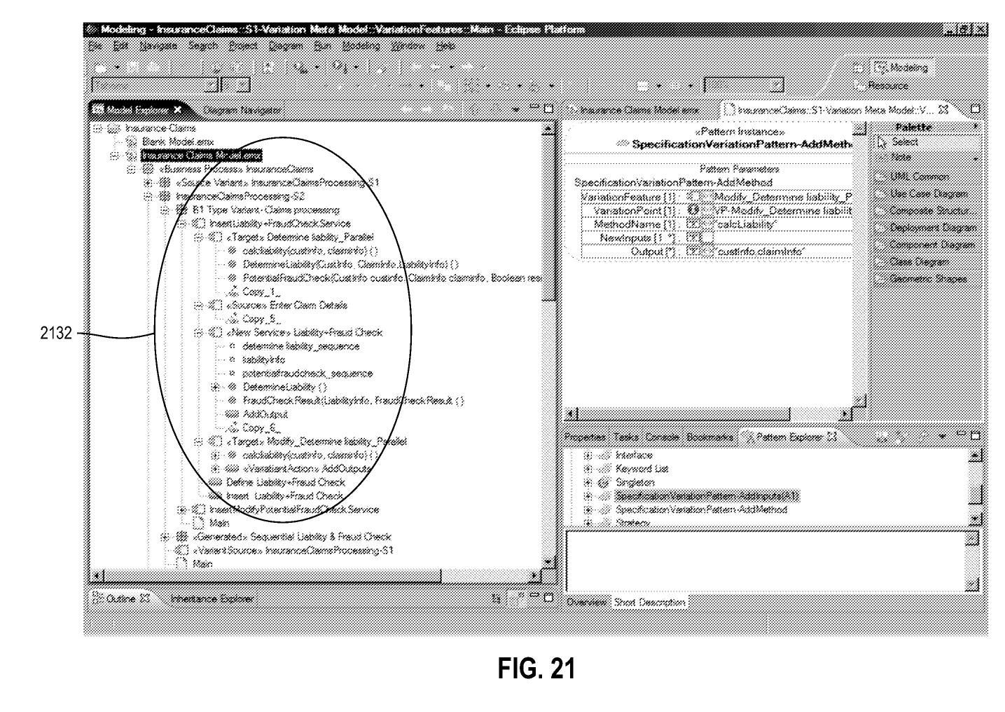

Application of a B1-type variation feature 2132 (creation of the Liability and Fraud Checks service 411) is depicted in FIG. 21. Since this is a business process level variation feature, it is applied to the overall business process level itself. The B1-type variant is associated with its constituent A-type variation features, as shown in FIG. 21.

### Aspect-Based Refactoring

The need for this step arises if either any manually generated code, or external/“legacy” components without an accompanying design model, have to be integrated into the solution as part of the required variation change. One example is the A1-type change for Potential Fraud Check service 411(b), in case when an external fraud checking algorithm has to be incorporated into this service. In such a situation, only a so-called method stub, i.e. the method signature without implementation details, is incorporated into the design model during Model Composition. This is used as a placeholder for weaving in the required calling and return methods for integration with the external/legacy component. This can either be done manually or, in order to ensure speed and semantic correctness, can be automated via an aspect-based refactoring tool such as AJDT (http://www.eclipse.org/ajdt/). The use of the method stub to represent external components in the model and variations that have not being anticipated in advance, facilitates future reuse by integrating these methods into the variation meta-model as additional Variation Feature Types, once the development of Solution 2 is completed.

### Evaluation

An implementation of a prototype of the discussed method for developing reusable SOA-based solutions has indicated that the method offers:

Simplified upfront variation modelling. A- and B-type variations are easily created and applied to existing solutions in the RSA tool.

Controlled variations to reusable assets. VOE only admits the application of variations from the set variation features already created within RSA. This permits SOA-based solutions to be only varied in a controlled manner, thereby alleviating the problem of haphazard modifications plaguing the software industry today.

Record and organizational memory of variations. Implementation of controlled variations with tool support creates a record of variations applied to solutions over a period of time, enabling provenance.

### To Summarize:

Business processes are arranged into groups of processes with similar functionality, as determined for a domain by an expert, and variants are modelled in each group;

Component implementations are also arranged into groups, and variants in implementations are modelled in each group;

For each process variant in a group, an implementation is found by mapping the implementation to the appropriate variant from the component implementations

Consistency is enforced of the above mapping by explicitly modelling the correctness constraints and enforcing them at the time of mapping.

Variants are modelled in a more expressive manner than it has been done previously. Variations have been grouped according to Variation Features (VF), i.e., characteristics of features, and are recorded at variation points. One benefit of VF modelling is that similar variations can now be found easily using the shared VFs.

Throughout this specification the term “business process” refers to code that is executable on at least one type of processing device, such as a processor, controller etc. Thus, such a business process could be directed to a computer processor, a server processor, embedded software processor, mobile phone processor etc.

It is obvious from the above description that, whilst some of the components of the above method can be performed manually, the method is generally designed to be executed by one or more processors, residing on a single computer or other electronic device, or in a distributed electronic systems. Accordingly, the above described method is closely associated with such computer and/or other electronic system, as well as with the corresponding executable code that, upon execution, effects the various steps of the discussed method on the respective processor/s. The executable code is typically stored on some form of storage medium, such as hard drive, read-only memory or resides in portable carriers, such as CD-s and DVD-s.

TABLE 2
Additional B-type Constraints
(A)
B2-type Variation - Constraint Formulation
Constraints at Business Process Level

(B2) Deleting a service - derived A-type changes

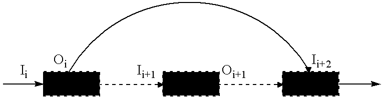

A2-type change for Sᵢ and A1/A2-type change for Sᵢ₊₂, depending on
change semantics
Variation variables: A2-add-inputs, A2-remove-inputs, A2-add-outputs,
A2-remove-outputs, A2-edit-inputs, A2-edit-outputs, A1-add-inputs, A1-
add-outputs, A1-remove-inputs, A1-remove-outputs, A1-edit-inputs, A1-
edit-outputs
Variable Domains: A2-add-inputs = {Iᵢ₊₂}, A2-remove-outputs = {Oᵢ₊₁},
A2-remove-inputs = {Iᵢ₊₂, . . . }, A2-edit-outputs = {Oᵢ}
Constraints:
Any relation on service interface variable assignments which evaluates to
Boolean
Any relation on service interface variable and service implementation
variable assignments which evaluates to Boolean
Any relation on service interface variable assignments of different services
which evaluates to Boolean:
A2-edit-outputs for Sᵢ = A1-add-inputs for Sᵢ₊₂

B2-Type Variation - Constraint Formulation
Constraints at Service Level

(B2) Deleting a service

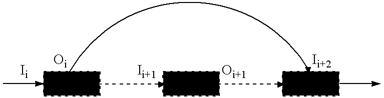

Variation variables: B2-add-inputs, B2-remove-inputs, B2-add-outputs,
B2-remove-outputs, B2-edit-outputs
Variable Domains: B2-add-inputs = {Iᵢ₊₂}, B2-remove-outputs = {Oᵢ₊₁},
B2-remove-inputs = {Iᵢ₊₂}, B2-edit-outputs = {Oᵢ}
Constraints:
Any relation on service interface variable assignments which evaluates
to Boolean
Any relation on service interface variable and service implementation
variable assignments which evaluates to Boolean
Any relation on service interface variable assignments of different services
which evaluates to Boolean:
B2-edit-outputs for Sᵢ = B2-add-inputs for Sᵢ₊₂

(B)
B3-type Variation - Constraint Formulation
Constraints at Business Process Level

(B3) Adding a new service in parallel

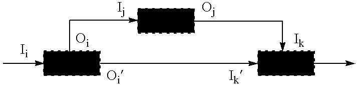

Variation variables: B3-add-inputs, B3-remove-inputs, B3-add-outputs,
B3-remove-outputs, B3-edit-inputs, B3-edit-outputs
Variable Domains: B3-add-inputs = {Iⱼ, Iₖ . . . },
B3-add-outputs = {Oⱼ, }, B3-
edit-outputs = {Oᵢ′), B3-edit-inputs = {Iₖ′}
Constraints:
Any relation on service interface variable assignments which evaluates to
Boolean: B3-add-outputs ≠ B3-edit-outputs for Sᵢ
Any relation on service interface variable and service implementation
variable assignments which evaluates to Boolean
Any relation on service interface variable assignments of different services
which evaluates to Boolean: B3-edit-outputs for Sᵢ = B3-edit-inputs for Sₖ

B3-type Variation - Constraint Formulation
Constraints at Service Level

(B3) Adding a new service in parallel - derived A-type changes

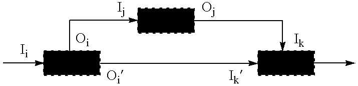

A1/A2-type changes for Sᵢ and Sᵢ₊₁, depending on change semantics
Variation variables: A2-add-inputs, A2-remove-inputs, A2-add-outputs,
A2-remove-outputs, A2-edit-inputs, A2-edit-outputs, A1-add-inputs, A1-
add-outputs, A1-remove-inputs, A1-remove-outputs, A1-edit-inputs, A1-
edit-outputs
Variable Domains: A2-add-inputs = {Iⱼ, Iᵢ₊₁ . . . },
A2-add-outputs = {Oⱼ, },
A2-edit-outputs = {Oᵢ′}, A1-edit-inputs = {Iₖ′}, . . .
Constraints:
Any relation on service interface variable assignments which evaluates to
Boolean: A2-add-outputs ≠ A2-edit-outputs for Sᵢ
Any relation on service interface variable and service implementation
variable assignments which evaluates to Boolean
Any relation on service interface variable assignments of different services
which evaluates to Boolean: A2-edit-outputs for Sᵢ ≠ A2-edit-inputs
for Sₖ

(C)
B4-Type Variation - Constraint Formulation
Constraints at Business Process Level

(B4) Adding a new dependency between two services

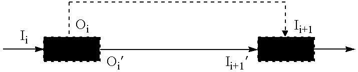

Variation variables: B4-add-outputs, B4-add-inputs
Variable Domains: B4-add-inputs = {Iᵢ₊₁}, B4-add-outputs = {Oᵢ}
Constraints:
Any relation on service interface variable assignments which evaluates to
Boolean: B4-add-inputs ≠ Iᵢ₊₁′ for Sᵢ₊₁
Any relation on service interface variable and service implementation
variable assignments which evaluates to Boolean: B4-add-outputs ≠ Oᵢ′
for Sᵢ
Any relation on service interface variable assignments of different services
which evaluates to Boolean: B4-add-outputs for Sᵢ = B4-add-inputs for Sᵢ₊₁

B4-type variation - Constraint Formulation
Constraints at Business Process Level

(B4) Adding a new dependency between two services -
derived A-type changes

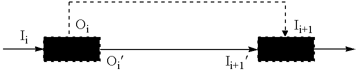

A2-type change for Sᵢ, and A1/A2-type change for Sᵢ₊₁, depending on
change semantics
Variation variables: A2-add-inputs, A2-remove-inputs, A2-add-outputs,
A2-remove-outputs, A2-edit-inputs, A2-edit-outputs, A1-add-inputs, A1-
add-outputs, A1-remove-inputs, A1-remove-outputs, A1-edit-inputs, A1-
edit-outputs
Variable Domains: A2-add-inputs = {Iᵢ₊₁}, A2-add-outputs = {Oᵢ}
Constraints:
Any relation on service interface variable assignments which evaluates to
Boolean: A2-add-inputs ≠ Iᵢ₊₁′ for Sᵢ₊₁
Any relation on service interface variable and service implementation
variable assignments which evaluates to Boolean: A2-add-outputs ≠ Oᵢ′
for Sᵢ
Any relation on service interface variable assignments of different services
which evaluates to Boolean:
A2-add-outputs for Sᵢ = A2-add-inputs for Sᵢ₊₁

(D)
B5-type Variation - Constraint Formulation
Constraints at Business Process Level

(B5) Deleting an existing dependency between two services

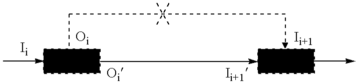

Variation variables: B5-remove-inputs, B5-remove-outputs
Variable Domains: B5-remove-inputs = {Iᵢ₊₁}, B5-remove-outputs = {Oᵢ}
Constraints:
Any relation on service interface variable assignments which evaluates to
Boolean
Any relation on service interface variable and service implementation
variable assignments which evaluates to Boolean: B5-remove-outputs ≠
Oᵢ′ for Sᵢ
Any relation on service interface variable assignments of different services
which evaluates to Boolean:
B5-remove-outputs for Sᵢ = B5-remove-inputs for Sᵢ₊₁

B5-type Variation - Constraint Formulation

(B5) Deleting an existing dependency between two services -
derived A-type changes

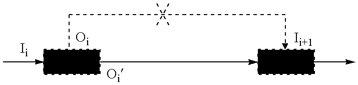

A2-type change for Sᵢ, and A1/A2-type change for Sᵢ₊₁,
depending on change semantics
Variation variables: A2-add-inputs, A2-remove-inputs, A2-add-outputs,
A2-remove-outputs, A2-edit-inputs, A2-edit-outputs, A1-add-inputs, A1-
add-outputs, A1-remove-inputs, A1-remove-outputs, A1-edit-inputs, A1-
edit-outputs
Variable Domains: A2-remove-inputs = {Iᵢ₊₁}, A2-remove-outputs =
{Oᵢ}, . . .
Constraints:
Any relation on service interface variable assignments which evaluates to
Boolean
Any relation on service interface variable and service implementation
variable assignments which evaluates to Boolean: A2-remove-outputs ≠
Oᵢ′ for Sᵢ
Any relation on service interface variable assignments of different services
which evaluates to Boolean:
A2-remove-outputs for Sᵢ = A1-remove-inputs for Sᵢ₊₁

We claim:

1. A method for generating, based on an original business process model and implementation comprising at least one component, a variant business process model and implementation comprising at least one variation compared to the original business process model and implementation, and which generates the same outputs for the same inputs as of the original business process model and implementation, the method comprising the steps of:
developing a meta-model of the business process model, comprising a static meta-model portion and a variant meta-model portion, representing the at least one variation;
instantiating and verifying the developed variant meta-model portion to obtain a variant model; and
implementing the variant model to generate the variant business process implementation.

2. The method of claim 1, all the limitations of which are incorporated herein, wherein developing the variant meta-model portion further comprises:
identifying at least one variation point, the at least one variation point indicating a location in the original business process model where variation can be introduced;
identifying at least one variation feature specifying the nature and the specific applicability of variation to be introduced; and
obtaining a variation instance by applying a variation feature to a corresponding variation point.

3. The method of claim 2, all the limitations of which are incorporated herein, wherein the at least one variation point is:
an implementation variation point, identifying a location in a respective component, in which the implementation of at least one method can be modified; or a specification variation point, identifying a location in a respective interface that can be modified.

4. The method of claim 3, all the limitations of which are incorporated herein, wherein:
variations are applied at a business process level and a component level comprising semantic rules defined for each variation.

5. The method of claim 4, all the limitations of which are incorporated herein, wherein the variation instances of a business process are categorised as;
component-level variations, which do not require a variation in the process flow; and
business process-level variations that relate to the application flow of the business process, each external variation being realized via a combination of component-level variations.

6. The method of claim 5, all the limitations of which are incorporated herein, wherein an internal variation is defined by:
a change only to the internal implementations of the components, without requiring changes to their interfaces or a change in the interfaces of the components thereby requiring implementation changes.

7. The method of claim 5, all the limitations of which are incorporated herein, wherein an internal variation effects at least one of:
adding component sequentially;
adding component in parallel;
deleting component;
adding dependency between two components; and
deleting dependency between two components.

8. The method of claim 1, all the limitations of which are incorporated herein, wherein step b) comprises enhancing the model by performing the steps of:
modeling variations at the component and business process levels; and
representing formally the variations by using a constraint based formulation in order to verify that the variant business process model and implementation generate the same outputs for the same inputs as of the original business process model and implementation.

9. The method of claim 8, all the limitations of which are incorporated herein, wherein the constraint-based formulation comprises:
variation variables, representing the basic change constructs;
variable domains, representing values that apply to each variation variable; and
constraints, representing the constraints against any subset of the variation variables.

10. The method of claim 8, all the limitations of which are incorporated herein, wherein the constraint-based formulation comprises equality or inequality constraints.

11. The method of claim 1, all the limitations of which are incorporated herein, wherein the step c) comprises:
composing variation models for each variation into a business process model of the variant; and
integrating un-automated and external components into the model.

12. The method of claim 11, all the limitations of which are incorporated herein, wherein the external components comprise legacy components.

13. The method of claim 1, all the limitations of which are incorporated herein, wherein the variant business process is generated semi-automatically.

14. An electronic system that is programmable for generating, based on an original business process model and implementation comprising at least one component, a variant business process model and implementation comprising at least one variation compared to the original business process model and implementation, the electronic system comprising computational means programmable for;
developing a meta-model comprising a static meta-model portion and a variant meta-model portion, representing the at least one variation;
instantiating and verifying the developed variant meta-model portion to obtain a variant model;
implementing the variant model to generate the variant; and
using a developed formalism to define the at least one variation.

15. The electronic system of claim 14, all the limitations of which are incorporated herein, wherein the system is also programmable for;
identifying at least one variation point, the at least one variation point indicating a location in the original business process model where variation can be introduced;
identifying at least one variation feature specifying the nature and the specific applicability of variation to be introduced; and
obtaining a variation instance by applying a variation feature to a corresponding variation point.

16. The electronic system of claim 15, all the limitations of which are incorporated herein, wherein the at least one variation point is:
an implementation variation point, identifying a location in a respective component, in which the implementation of at least one method can be modified; or a specification variation point, identifying a location in a respective interface that can be modified.

17. The electronic system of claim 16, all the limitations of which are incorporated herein, wherein the system is so programmed that;
variations are applied at a business process level and a component level comprising semantic rules defined for each variation.

18. The electronic system of claim 17, all the limitations of which are incorporated herein, wherein the system is so programmed that the variation instances of a business process are categorised as;
component-level variations, which do not require a variation in the process flow; and
business process-level variations that relate to the application flow of the business process, each external variation being realized via a combination of component-level variations.

19. The electronic system of claim 18, all the limitations of which are incorporated herein, wherein the system is so programmed that an internal variation is defined by:
a change only to the internal implementations of the components, without requiring changes to their interfaces or a change in the interfaces of the components thereby requiring implementation changes.

20. A computer program product having a computer readable medium having an executable computer program recorded therein for automatically generating, based on an original business process comprising at least one component, a variant business process comprising at least one variation compared to the original business process, said computer program comprising;
developing a meta-model of the business process, the meta model comprising a static meta-model portion and a variant meta-model portion, representing the at least one variation;
instantiating and verifying the developed variant meta-model portion to obtain a variant model;
implementing the variant model to generate the variant; and
using the developed formalism to define the at least one variation.
